(19) United States
(12) Patent Application Publication
(10) Pub. No.: US 2004/0157945 A1
(43) Pub. Date: Aug. 12, 2004

(54) Rigid urethane foams

(76) Inventor: Thomas Allan Barber, Hendersonville, TN (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/741,467

(22) Filed: Dec. 19, 2003

Related U.S. Application Data
(60) Provisional application No. 60/436,950, filed on Dec. 30, 2002.

(51) Int. Cl. C08G 18/00

(52) U.S. Cl. 521/155

(57) ABSTRACT

Rigid urethane foams made from polyester polyols and processes for producing them are provided. The foams are made by reacting a mixture that comprises an aromatic polyester polyol having an average functionality of about 3.0 or less, a hydroxyl number above 100 mg/KOH/g, and an average molecular weight less than 3000; from about 1 weight percent to about 30 weight percent of a saccharide; a blowing agent; and an isocyanate, and said foams having an isocyanate index from about 0.8 to about 3.0. The foams have a high closed cell content and a high free rise compressive strength and slightly lower thermal resistance than expected for their density.

### PRIORITY

This application claims priority from provisional patent application No. 60/436,950, which was filed on Dec. 30, 2002, the disclosures of which are hereby incorporated herein by reference in their entirety.

### FIELD OF INVENTION

The present invention relates to rigid foams formed from polyester polyols.

### BACKGROUND OF THE INVENTION

The term “rigid foams” is commonly used to refer to plastics having a cell structure produced by an expansion process, known as “foaming”, and also having a comparatively low weight per unit volume and relatively low thermal conductivity. Optionally, the foaming process can be carried out substantially simultaneously with the forming of the plastic material. Such rigid foams are often used as insulators for noise abatement and/or as heat insulators in construction, in cooling and heating technology such as for household appliances, for producing composite materials, such as sandwich elements for roofing and siding, and for wood simulation material, model-making material, and packaging.

Rigid foams based on polyurethane and polyisocyanurate are known and are produced, for example, by an exothermic reaction of a polyol with an isocyanate. Foams made using a stoichiometrically balanced mixture of polyol and isocyanate are known as polyurethane foams. If a sufficient excess of isocyanate is used, isocyanurates are formed by trimerization of isocyanate, leading to increased crosslinking and increased thermal and flame resistance and low smoke generation during burning; however, some such materials may not have desirable mechanical properties for certain applications. Encyclopedia of Polymer Science and Engineering. 2nd ed. J. Kroschwitz. Exec. Ed. (John Wiley & Sons, NY (1988), vol. 3, p. 27.

The speed of reaction in forming a foam can be adjusted by the use of a suitable activator. In order to provide foaming, use is made of an inflating agent, typically soluble in the polyol, with a suitable boiling point, that becomes a gas upon reaching its boiling point and thereby produces pores, referred to as “cells”. To improve flowability of the foaming reactants during manufacture of foams to be used in molding or panels, water is generally added to the polyol and reacts with the isocyanate, forming carbon dioxide, which acts as an additional inflating agent.

Surfactants can be added to the reactants to assist in cell formation, and nucleation by, for example, charging of the foaming mixture with a gas can be used to enhance cell structure. It is desirable, in the formation of rigid foams, to obtain as many small, closed cells as possible.

Concerns about the deleterious environmental effects of chlorofluorocarbons and hydrochlorofluorocarbons have resulted in a need for effective, environmentally benign replacements. Carbon dioxide produced when water is added to the isocyanate/polyol mixture can be used as an inflating agent, but its thermal conductivity is higher than the thermal conductivity of the fluorocarbons, which adversely affects the insulating capability of foams made using carbon dioxide.

U.S. Pat. No. 5,034,424 to Wenning et al. discloses rigid foams, including a closed-cell polyurethane or polyisocyanurate rigid foam, that includes a cell structure formed by the expansion of rigid foam raw materials with carbon dioxide as an inflating agent, and one other inflating agent that is substantially insoluble in at least one of the raw materials, i.e., polyols and isocyanates, used to make the foam. The insoluble inflating agent is emulsified in at least one of the rigid foam raw materials prior to the reaction between the polyol and isocyanate. The inflating agent is provided in the disperse phase of an emulsion having a liquid droplet size of 10 μm or less in diameter. Less than 3.5 weight % of the rigid foam material is the inflating agent. Activators and/or stabilizers are optionally added to form the cell structure. Wenning also discloses the use of particulate nucleating agents, i.e., silica gel and starch.

There remains a need for fine closed-cell rigid foams with high insulation value, high compressive strength, and low flame spread.

### SUMMARY OF THE INVENTION

One aspect of the present invention is a process for forming a rigid, closed cell foam having an isocyanate index of from about 0.8 to about 3.0. The process comprises reacting a mixture that comprises an aromatic polyester polyol having an average hydroxyl functionality of about 3.0 or less, a hydroxyl number greater than 100 mg/KOH/g, and an average molecular weight less than 3000; from about 1 weight percent to about 30 weight percent of a saccharide, based on the total weight of the mixture; a blowing agent that comprises water; and an isocyanate having an average functionality of 3.0 or less.

In some preferred embodiments, the amount of the saccharide is from about 2 weight percent to about 10 weight percent.

Preferably, the isocyanate index of the foam is about 2.7 or less. In some preferred embodiments, the isocyanate index of the foam is from about 0.8 to about 2.5. In other preferred embodiments, the isocyanate index is from about 1.0 to about 1.7. In certain highly preferred embodiments, the isocyanate index is from about 1.05 to about 1.3.

In some embodiments, the average functionality of the isocyanate is 2.7 or less.

In some embodiments, the polyol has an average functionality of 2.5 or less. In some embodiments, the polyol has an average functionality of 2.3 or less.

Another aspect of the present invention is a rigid, closed cell foam. The foam is formed from a process comprising reacting a mixture that comprises an aromatic polyester polyol having an average functionality of about 3.0 or less, a hydroxyl number greater than 100 mg/KOH/g, and an average molecular weight less than 3000; from about 1 weight percent to about 30 weight percent of a saccharide, based on the total weight of the mixture; a blowing agent that comprises water; and an isocyanate having an average functionality of 3.0 or less. The foam has an isocyanate index from about 0.8 to about 3.0

These and other aspects of the invention will be apparent to one skilled in the art, in view of the following disclosure and the appended claims.

### BRIEF DESCRIPTION OF THE DRAWINGS

FIG. 1 is a drawing depicting an apparatus used for forming the rigid foam of the present invention.

FIG. 2 is an example of an optical confocal micrograph image of a foam produced according to Example 3.

FIG. 3 is a scanning electron micrograph of a foam produced according to Example 3.

### DETAILED DESCRIPTION

It has been surprisingly found that rigid urethane foams having desirable high closed cell content and compressive strength can be produced by reaction between low functional isocyanates, defined herein as isocyanates having an average functionality of 3.0 or less, preferably 2.7 or less; and polyols having average hydroxy functionality of about 3.0 or less, preferably 2.5 or less, more preferably 2.3 or less, even more preferably 2.0 or less, in the presence of a saccharide. It was unexpected that isocyanates and polylols having such low functionalities could be used to make rigid urethane foams having a high closed cell content, and high insulation values and compressive strength, by including a saccharide in the composition and process used in making the foams.

The foams can be made using a blowing agent that contains water. Preferably, the blowing agent is substantially water or consists essentially of water. For example, a blowing agent that is “substantially water” can be 85, 90, 95, 98, or 99% water. In some embodiments, the blowing agent consists entirely of water. In some embodiments, a hydrocarbon can be used in combination with water as a “co-blowing agent”.

While it is not intended that the present invention be bound by any particular theory or mechanism, it is believed that hydrogen bonding involving the saccharide, and/or rapid polymer crosslinking due to the presence of the saccharide, builds viscosity quickly and keeps the gas generated by the blowing agent finely dispersed. It is further believed that the saccharide can act as a cell nucleation site.

Unless otherwise stated, the following terms as used herein have the following definitions.

A “rigid” foam is a foam that ruptures when a 20×2.5 X 2.5 cm piece of the foam is wrapped around a 2.5 cm mandrel rotating at a uniform rate of 1 lap per second at 15-25° C. In contrast, a 20×2.5 X 2.5 cm piece of a less rigid foam, e.g., a “non-rigid” foam, would generally collapse under the same test conditions.

“Hydroxyl number” of a polyol refers to the concentration of hydroxyl groups, per unit weight of the polyol, that are able to react with isocyanate groups. Hydroxyl number is reported as mg KOH/g, and is measured according to the standard ASTM D 1638.

“Acid number” means the concentration of carboxylic acid groups present in the polyol, and is reported in terms of mg KOH/g and measured according to standard ASTM 4662-98.

The “average functionality”, or “average hydroxyl functionality” of a polyol indicates the number of OH groups per molecule, on average. The average functionality of an isocyanate refers to the number of —NCO groups per molecule, on average.

“Glycols” or “dihydric alcohols” are low molecular weight hydroxy compounds containing 2 hydroxyl groups, preferably having an average molecular weight of about 62 to 260.

“Polyhydroxyl polyols” or “polyhydric alcohols” are low molecular weight hydroxy compounds containing 3 to 8 hydroxyl groups, preferably having an average molecular weight of about 90 to about 350.

“Polyisocyanate” indicates an organic isocyanate component that has two or more isocyanate functionalities.

“Isocyanate index” indicates the ratio of isocyanate equivalents actually used to the stoichiometrically calculated amount based on hydroxyl groups. Another term for “isocyanate index” is “NCO:OH ratio”.

Foams such as those described herein as having a “high closed cell content” have a relatively small fraction of noninterconnecting cells, in contrast to foams having a large fraction of interconnecting cells, which are commonly termed “open-celled foams”. A foam having a high closed cell content can nonetheless have some interconnected cells.

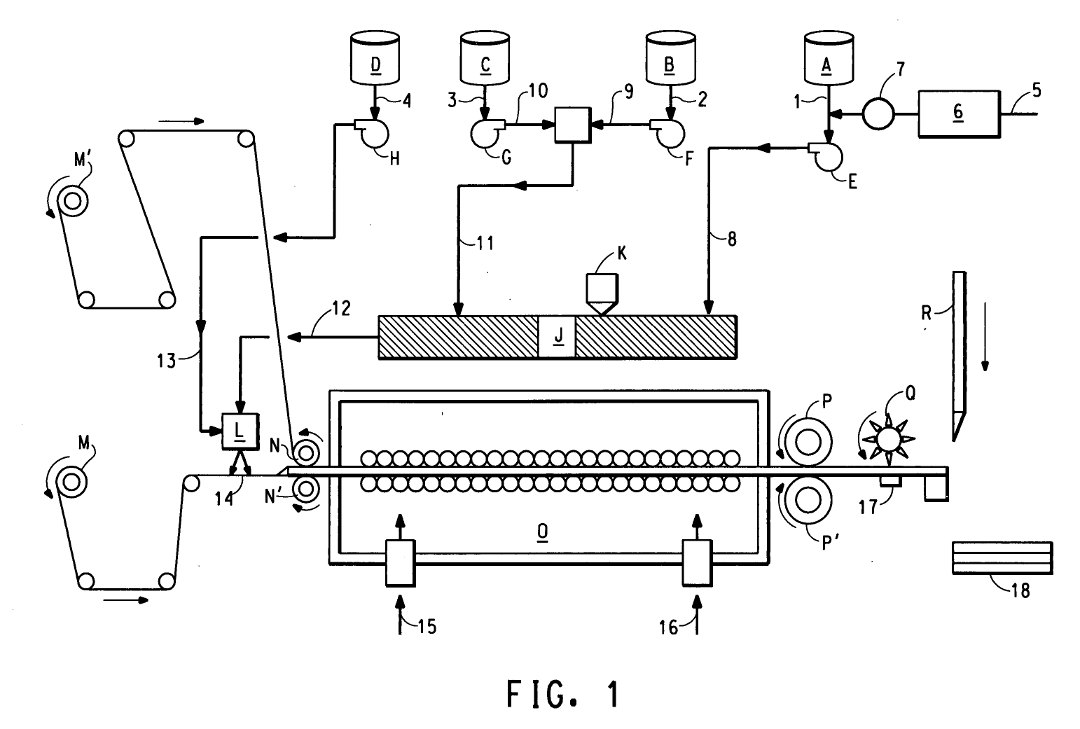

In polyisocyanate-based foam production, when ingredients are mixed together from different tanks (as shown, for example, in FIG. 1) conventional terminology is used as follows to designate the components mixed together to make a foam. Such conventional terminology is also used herein, unless otherwise stated. In particular:

“A-side” refers to a liquid component containing polyisocyanate. “A-side” can also refer to a delivery system or portion of equipment from which the polyisocyanate is delivered. Similarly, other terms such as “B-side”, “C-side” and “D-side” can refer to equipment delivering a particular component.

“B-side” refers to a liquid component containing a polyol, a surfactant, and a blowing agent.

“C-side” refers to a component containing optional additional blowing agent, which may be referred to herein as a “co-blowing agent.”

“D-side” refers to a component containing a catalytic agent.

“Saccharide”, as used herein, means a compound containing a sugar moiety, and includes sugar molecules of any length including monosaccharides (e.g. sorbitol), disaccharides (e.g. sucrose), trisaccharides (e.g. raffinose), tetrasaccharides (e.g. stachyose), olgiosaccharides, and polysaccharides (e.g. flour). Unmodified saccharides, such as unmodified starch, which contain fatty acid groups in ester form, are included within the definition of “saccharide” as used herein.

The foams, which have an isocyanate index of from about 0.8 to about 3.0, are formed from a reaction mixture including an aromatic polyester polyol, an isocyanate, a saccharide, and a blowing agent comprising water. The mixture contains from about 1 weight percent to about 30 weight percent of the saccharide, based on the total weight of the mixture.

The aromatic polyester polyol preferably has an average functionality of about 3.0 or less. Also preferably, the aromatic polyester polyol also has a hydroxyl number above 100 mg/KOH/g. In some preferred embodiments, the aromatic polyester polyol has an average molecular weight less than 3000. More preferably, the average functionality of the aromatic polyester polyol is 2.5 or less, more preferably 2.3 or less. Also preferably, the aromatic polyester polyol has a hydroxyl number of 650 or less, more preferably a hydroxyl value of 450 or less. The hydroxyl number of the aromatic polyester polyol is preferably about 250 or greater. In some preferred embodiments, the aromatic polyester polyol has an average molecular weight of 350 or greater. In some preferred embodiments, the aromatic polyester polyol has a molecular weight of 800 or less. The amount of aromatic polyester poyol is not critical, provided the criteria hereinabove for hydroxyl values are met. The exact amount of polyol needed depends upon the desired index of the foam, and can be determined by one skilled in the art.

Suitable aromatic polyester polyols for use in making the foams are reaction products of a reaction mixture comprising: an acid component, a glycol component, and optionally a polyhydroxl polyol. Preferably a urethane catalytic activity agent is also present. Preferred aromatic polyester polyols are described in co-pending U.S. patent application Ser. No. 10/619,722, filed on Jul. 15, 2003, the disclosure of which is hereby incorporated by reference herein in its entirety.

Preferred aromatic polyester polyols used in the processes disclosed herein have, as a molar percentage of the total acid groups in the acid component used to make a particular polyol, a molar aromatic content of at least about 10%, i.e., a molar aliphatic acid content of about 90% or less. Preferably, the aromatic acid portion of the total acid is at least about 40 mol %, more preferably at least about 50 mol %, even more preferably at least about 60 mol %, still more preferably at least about 70 mol %, still even more preferably at least about 80 mol %, yet even more preferably at least about 90 mol %, and most preferably, about 100 mol %.

The acid component used in making the aromatic polyester polyol can include a carboxylic acid or acid derivative, such as an anhydride or ester of the carboxylic acid. Examples of suitable carboxylic acids and derivatives thereof useful as the acid component for the preparation of the aromatic polyester polyol include: oxalic acid; malonic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester. While the acid component can be a substantially pure reactant material, the acid component is preferably a side-stream, waste, or scrap residue from the manufacture of compounds such as, for example, phthalic acid, terephthalic acid, dimethyl terephthalate, polyethylene terephthalate, polybutylene terephthalate, polytrimethylene terephthalate, and adipic acid. Preferred aromatic carboxylic acid components include ester-containing by-products from the manufacture of dimethyl terephthalate, scrap polyalkylene terephthalates, phthalic anhydride, residues from the manufacture of phthalic anhydride, terephthalic acid, residues from the manufacture of terephthalic acid, isophthalic acid, trimellitic anhydride, residue from the manufacture of trimellitic anhydride, aliphatic polybasic acids or esters derived therefrom, scrap resin from the manufacture of biodegradable polymers such as Biomax® polymers (E. I. du Pont de Nemours and Company, Wilmington, Del.), and by-products from the manufacture of polyalkylene terephthalate.

The glycol component used in making the aromatic polyester polyol can be aliphatic, cycloaliphatic, aromatic and/or heterocyclic. Preferably, the glycol component is an aliphatic dihydric alcohol having no more than about 20 carbon atoms. In one embodiment, the glycol comprises ethylene glycol, propylene glycol; diethylene glycol; triethylene glycol; polyethylene glycol; dipropylene glycolbutylene glycol-(1,4) and -(2,3); hexanediol-(1,6); octane diol-(1,8); neopentyl glycol; 1,4-bishydroxymethyl cyclohexane; 2-methyl-1,3-propane diol, or a mixture thereof. Sources of glycols include scrap, referred to as “bottoms”, from the distillation of products such as ethylene glycol, diethylene glycol, triethylene glycol, and higher homologs or mixtures thereof. Members of the homologous series of propylene glycols can also be used, including, for example, dipropylene glycol, tripropylene glycol, and higher homologs and mixtures thereof. Glycols can also be generated in situ during preparation of the aromatic polyester polyols by depolymerization of polyalkylene terephthalates. For example, depolymerization of polyethylene terephthalate yields ethylene glycol. Amino alcohols, such as, for example, monoethanolamine, diethanolamine, triethanolamine, or the like, can be used as a glycol component. Triethanolamine or side a stream material such as the bottoms from triethanol amine refining is preferred.

The glycol component can optionally include substituents that are inert in the reaction that forms the polyol, such as, for example, chlorine and bromine substituents, and/or may be unsaturated. The most preferred glycol components are diethylene glycol and ethylene glycol generated in situ. In addition to or as an alternative to the glycols, any polyhydric alcohol can be used in preparing the polyester polyols. Suitable polyhydric alcohols for use in the processes and compositions disclosed herein can be aliphatic, cycloaliphatic, aromatic and/or heterocyclic. The polyol can optionally include substituents that are inert in the reaction between the polyol and the isocyanate, such as, for example, chlorine and bromine substituents, and/or may be unsaturated.

The aromatic polyester polyol can also contain one or more functionality-enhancing compounds, which are generally introduced during the process of making the polyol. Functionality-enhancing compounds are compounds having more than two reactive groups, such as hydroxyl groups and amine groups. Exemplary functionality-enhancing compounds include non-alkoxylated glycerol, non-alkoxylated pentaerythritol, non-alkoxylated alpha-methylglucoside, non-alkoxylated sucrose, non-alkoxylated sorbitol, non-alkoxylated trimethyolpropane, non-alkoxylated trimethylolethane, tertiary alkynol amines, and non-alkoxylated mono-, di- and poly-saccharides. Mixtures of two or more of such functionality-enhancing compounds can be used. Of the saccharides, saccharides that contain no aldehyde functionality, such as xylose, mannitol, and sorbitol are preferred. Triethanolamine can also act as a functionality-enhancing compound. The presence of one or more functionality-enhancing compounds may increase the functionality of the polyol. However, the presence of one or more such functionality-enhancing compounds in the polyol prior to the use of the polyol in making a foam is not intended to replace the use of a saccharide as one of the components used in making the foam according to the processes disclosed herein.

According to the present invention, it has been found that saccharides can be added directly to the foam-making mixture, and can thus provide enhanced functionality, allowing lower functionality components to be used in making the foam.

Exemplary saccharides include sorbitol, corn syrup, and flour, Preferably, the saccharide is present in the reaction mixture in an amount from about 2 weight percent to about 10 weight percent, more preferably from about 3 weight percent to about 5 weight percent, based on the total combined weight of all components in the reaction mixture. The saccharide can be in liquid form such as a syrup (e.g. corn syrup) or a solid (e.g. flour or a dried sugar). The amount of saccharide that can be used is limited by the total water content of the foam formulation contributed by the saccharide in liquid or solid form. It is preferred that the total water content does not exceed the amount of water required to achieve the desired foam density. The presence of co-blowing agents such as hydrocarabons can affect the density so that less water is needed. It has been surprisingly found that the addition of the saccharide to the B-side improves the dispersion of hydrocarbons into the B-side emulsion. It is highly preferred that the B-side be reacted with A-side components as quickly as possible after the B-side components have been combined, in order to minimize or eliminate handling problems such as precipitation of the saccharide from the B-side solution.

Polyisocyanates for use in making the foams can be selected from any organic polyisocyanates known to those skilled in the art. The term “polyisocyanate” is intended to include di-isocyanates and any isocyanates having more than two isocyanate functionalities. Examples of suitable organic polyisocyanates include aliphatic, cycloaliphatic, arylaliphatic, aromatic and heterocyclic polyisocyanates and combinations thereof that have two or more isocyanate (NCO) groups per molecule. The polyisocyanate is desirably present in such quantity that the NCO:OH ratio in the mixture is less than 3.0, preferably less than 2.7, more preferably less than 2.5, and more preferably less than 1.7. It is highly preferred that the isocyanate index be between about 1.0 and about 1.3.

Among the many polyisocyanates suitable for use in the processes disclosed herein are, for example, tetramethylene, hexamethylene, octamethylene and decamethylene diisocyanates, and their alkyl substituted homologs; 1,2-, 1,3- and 1,4-cyclohexane diisocyanates; 2,4- and 2,6-methyl-cyclohexane diisocyanates; 4,4′- and 2,4′-dicyclohexyl-diisocyanates; 4,4′- and 2,4′-dicyclohexylmethane diisocyanates; 1,3,5-cyclohexane triisocyanates; saturated (hydrogenated) polymethylenepolyphenylene polyisocyanates; isocyanatomethylcyclohexane-isocyanates; isocyanatoethyl-cyclohexane isocyanates; bis(isocyanatomethyl)-cyclohexane diisocyanates; 4,4′- and 2,4′-bis(isocyanatomethyl) dicyclohexane; isophorone diisocyanate; 1,2-, 1,3-, and 1,4-phenylene diisocyanates; 2,4- and 2,6-toluene diisocyanate; 2,4′-, 4,4′- and 2,2-biphenyl diisocyanates; 2,2′-, 2,4′- and 4,4′-diphenylmethane diisocyanates; polymethylenepolyphenylene-polyisocyanates (polymeric MDI); and aromatic aliphatic isocyanates such as 1,2-, 1,3-, and 1,4-xylylene diisocyanates.

Organic polyisocyanates containing heteroatoms can be used, such as, for example, those derived from melamine. Polyisocyanates modified by carbodiimide or isocyanurate groups can be used. Also useful are liquid carbodiimide group- and/or isocyanurate ring-containing polyisocyanates having an isocyanate content of 15 wt % to 33.6 wt %, preferably 21 wt % to 31 wt %, are also effective, such as those based on 4,4′-, 2,4′-, and/or 2,2′-diphenylmethane diisocyanate and/or 2,4- and/or 2,6-toluene diisocyanate, and preferably 2,4- and 2,6-toluene diisocyanate and the corresponding isomer mixtures, 4,4′-, 2,4′, and 2,2′-diphenylmethane diisocyanates as well as the corresponding isomer mixtures, for example, mixtures of 4,4′- and 2,4′-diphenylmethane diisocyanates, mixtures of diphenylmethane diisocyanates (MDI) and polyphenyl polymethylene polyisocyanates (polymeric MDI), and mixtures of toluene diisocyanates and polymeric MDI.

Still other useful organic polyisocyanates are isocyanate terminated prepolymers. Isocyanate terminated prepolymers are prepared by reacting an excess of one or more organic polyisocyanates with a minor amount, e.g., about 10 weight percent or less, based on the weight of the polyisocyanate, of one or more active hydrogen-containing compounds. A large molar excess of isocyanate is desired, e.g, a molar excess of about 600% or greater, preferably up to about 900%. Suitable active hydrogen containing compounds for preparing prepolymers include those containing at least two active hydrogen-containing groups that are isocyanate reactive. Typifying such compounds are hydroxyl-containing polyesters, polyalkylene ether polyols, hydroxyl-terminated polyurethane oligomers, polyhydric polythioethers, ethylene oxide adducts of phosphorous-containing acids, polyacetals, aliphatic polyols, aliphatic thiols including alkane, alkene, and alkyne thiols having two or more SH groups, as well as mixtures thereof. Compounds that contain two or more different groups within the above-defined classes may also be used such as, for example, compounds that contain both a SH group and an OH group. Highly useful prepolymers are disclosed in U.S. Pat. No. 4,791,148 to Riley et al., the disclosures of which are hereby incorporated herein by reference.

Preferred polyisocyanates are aromatic diisocyanates and aromatic polyisocyanates. Particularly preferred are 2,4′-, 2,2′- and 4,4′-diphenylmethane diisocyanate (MDI), polymethylene polyphenylene polyisocyanates (polymeric MDI), and mixtures of the above preferred polyisocyanates. Most particularly preferred are the polymeric MDIs. A preferred polymeric MDI is a polymeric diphenylmethane 4,4′-diisocyanate with a dynamic viscosity of 60 to 3000 cPs at room temperature, more preferably 200 to 2000 cPs, and most preferably 400 to 800 cPs.

Water is a preferred blowing agent. In preferred embodiments, the blowing agent consists essentially of water or is entirely water. A preferred amount of water for use as a blowing agent when used with hydrocarbons in making the foams is from about 0.4 weight % to about 1.0 weight % based on the total weight of the polymerized reaction mixture, more preferably from about 0.55 to about 0.65 weight %. Preferably, water is the sole blowing agent. In a preferred embodiment, when water is the sole blowing agent, the amount of water is from about 1.5 weight % to about 2.0 weight %, based on the total weight of the polymerized reaction mixture.

Optionally, one or more other blowing agents may be used. Such additional blowing agents are referred to herein as “co-blowing agents”. Co-blowing agents suitable for use in making the rigid foams include conventional blowing agents such as hydrocarbons and hydrofluorocarbons. Exemplary co-blowing agents are C₂-C₆ hydrocarbons and hydrofluorocarbons. Preferred co-blowing agents are isopentane, n-pentane, cyclopentane and 1,1,1,2-tetrafluoroethane. Mixtures of two or more co-blowing agents can be used. For example, pentane can be used as a co-blowing agent with water in an amount of about 5.0 weight % to 3.25 weight %, preferably about 4.6 weight %, based on the total weight of the polymerized reaction mixture. Total blowing agents are employed in an amount sufficient to give the resultant rigid foam the desired bulk density, generally between 0.5 and 10 pounds per cubic foot, preferably between 1 and 5 pounds per cubic foot, and more preferably between 1.5 and 2.5 pounds per cubic foot. The blowing agents are preferably present in the mixture used to make the foam in an amount from about 0.5 to about 20 wt %, more preferably from about 1 to about 15 wt %, based on the total weight of the mixture. When a blowing agent has a boiling point at or below ambient temperature, the blowing agent can be maintained under pressure until the blowing agent is mixed with the other components.

In some embodiments, a frothing agent can be used. A frothing agent, if used, introduces a gas into the polyol. Exemplary frothing agents are carbon dioxide, air, and nitrogen. Carbon dioxide is a preferred frothing agent, and is preferably introduced into the polyol in liquid form. Liquid carbon dioxide is introduced at a temperature below the gas transition temperature, and allowed to convert to carbon dioxide gas as the temperature is allowed to rise.

Any suitable surfactant can be employed in making the foams. Examples of suitable surfactants are compounds that regulate the cell structure of the foam by controlling the cell size in the foam and reducing the surface tension during foaming when foaming is carried out by reaction to make the polyol and, optionally, other components, with a polyisocyanate as described herein. Successful results have been obtained with silicone-polyoxyalkylene block copolymers, nonionic polyoxyalkylene glycols and their derivatives, and ionic organic salts as surfactants. Examples of other useful surfactants include polydimethylsiloxane-polyoxyalkylene block copolymers sold under the trade names Dabco® DC-193 and Dabco® DC-5315 (Air Products and Chemicals, Allentown, Pa.). Other suitable surfactants, including ether sulfates, fatty alcohol sulfates, sarcosinates, amine oxides, sulfonates, amides, sulfo-succinates, sulfonic acids, alkanol amides, ethoxylated fatty alcohol, and nonionics such as polyalkoxylated sorbitan, are described in U.S. Pat. No. 4,751,251 to Thornsberry, the disclosures of which are hereby incorporated herein by reference. The amount of surfactant used is preferably from about 0.02 wt % to about 2 wt %, based on the total weight of the foam-forming mixture, more preferably about 0.05 to about 1.0 wt.

Other optional additives can also be included. Examples of such additives include processing aids, viscosity reducers, such as 1-methyl-2-pyrolidinone, propylene carbonate, nonreactive and reactive flame retardants, dispersing agents, plasticizers, mold release agents, antioxidants, compatibility agents, and fillers and pigments (e.g., carbon black and silica). The use of such additives is well known to those skilled in the art.

Particulate nucleating agents are not required for making the foams according to the processes disclosed herein, although foams and processes made using particulate or other nucleating agents are within the scope of the present invention.

As recited above, the foams can include flame retardants (also referred to as flameproofing agents), which can be reactive or nonreactive. Examples of suitable flame retardants are tricresyl phosphate, tris(2-chloroethyl) phosphate, tris(2-chloropropyl) phosphate, and tris(2,3-dibromopropyl) phosphate. An exemplary flame retardant is Antiblaze® 80 flame retardant, which is a tris(chloro propyl)phosphate and is commercially available from Rhodia, Inc. (Cranbury, N.J.). Examples of reactive flame retardants include halogen-substituted phosphates, such as chlorenic acid derivatives, tetrabromophthalic anhydride and derivatives, and various phosphorous-containing polyols. Inorganic or organic flameproofing agents can also be used, such as red phosphorus, aluminum oxide hydrate, antimony trioxide, arsenic oxide, ammonium polyphosphate and calcium sulfate, expandable graphite or cyanuric acid derivatives, e.g., melamine, or mixtures of two or more flameproofing agents, e.g., ammonium polyphosphates and melamine, and, if desired, polysaccharides such as cornstarch and flour, or ammonium polyphosphate, melamine, and expandable graphite and/or, if desired, aromatic polyesters to enhance the flameproofing characteristics of the resulting foam product. In general, from 2 to 50 parts by weight, preferably from 5 to 25 total parts by weight of one or more flameproofing agents can be used per 100 parts by weight of the aromatic polyester polyol. In one preferred embodiment of the invention, Antiblaze® 80 flame retardant is used in combination with a polysaccharide. For example, equal weights of Antiblaze® 80 and a polysaccharide can be used.

The foams can also include fillers, including organic and inorganic fillers and reinforcing agents. Suitable inorganic fillers include silicate minerals, such as for example, phyllosilicates (e.g., antigorite, serpentine, hornblends, amphiboles, chrysotile, and talc); metal oxides, such as kaolin, aluminum oxides, titanium oxides and iron oxides; metal salts, such as chalk, barite and inorganic pigments, such as cadmium sulfide, zinc sulfide and glass; kaolin (china clay), aluminum silicate and co-precipitates of barium sulfate and aluminum silicate, and natural and synthetic fibrous minerals, such as wollastonite, metal, and glass fibers of various lengths. Suitable organic fillers include carbon black, melamine, colophony, cyclopentadienyl resins, cellulose fibers, polyamide fibers, polyacrylonitrile fibers, polyurethane fibers, and polyester fibers based on aromatic and/or aliphatic dicarboxylic acid esters, and carbon fibers.

The inorganic and organic fillers can be used individually or as mixtures and can be introduced into the aromatic polyester polyol foam forming mixture or isocyanate side in amounts of 0.1 wt % to 40 wt % based on the weight of the aromatic polyester polyol foam forming mixture or isocyanate side. For example, the filler and isocyanate can be fed together to the “A” side (isocyanate side), which forms a prepolymer that is then mixed with the material from the “B” side.

Further details as other conventional additives that can be used are described by J. H. Saunders and K. C. Frisch, High Polymers, Volume XVI, and Polyurethanes. Parts 1 and 2, Interscience Publishers 1962 and 1964, respectively; and Kunststoff-Handbuch, Polyurethane, Volume VII, Carl-Hanser-Verlag, Munich, Vienna, 1st and 2nd Editions, 1966 and 1983, the disclosures of each of which are hereby incorporated herein by reference

The rigid foams can be prepared by mixing together the organic polyisocyanate with the polyol and other ingredients at temperatures ranging from about 0° C. to about 150° C. Any order of mixing is acceptable provided the reaction of the polyisocyanate and aromatic polyester polyol does not begin until substantially all of the polyisocyanate and substantially all of the polyester polyol are mixed. Preferably, the polyisocyanate and the aromatic polyester polyol do not react until all ingredients have been combined. In a preferred embodiment, the B-side and A-side components are mixed for a short time together in an extruder with a blowing or foaming agent prior to the addition of D-side component at the point of the mixing equipment where all components come together, known as the “mixing head”. Alternatively, all components can be fed directly to the mixing head.

The foams can be produced by discontinuous or continuous processes, with the foaming reaction and subsequent curing being carried out, for example, in molds or on conveyors. The foam product can be suitably produced as a foam laminate by (a) contacting at least one facing sheet with the foam-forming mixture, and (b) foaming the mixture. The process for making the foam as a laminate is advantageously conducted in a continuous manner by depositing the foam-forming mixture onto a facing sheet(s) being conveyed along a production line, and preferably placing another facing sheet(s) on the deposited mixture. The deposited foam-forming mixture is conveniently thermally cured at a temperature from about 20° C. to 150° C. in a suitable apparatus, such as an oven or heated mold. Both free rise and restrained rise processes may be employed in the foam production.

A feature of foams prepared according to the processes described herein is a relatively small cell size, as compared to conventional closed-cell foams made from isocyanurates. The small cell size is believed to contribute to certain advantages of the foams, including 180-day aged as measured according to ASTM C518, and long-term thermal resistance as measured according to CAN/ULC-S770.

The foams have R values of at least about 4.5 R/in., preferably at least about 5.0 R/in., more preferably at least about 5.5 R/in., and even more preferably at least about 6 R/in.

### EXAMPLES

The following examples are provided to further illustrate the invention and are not to be construed as to unduly limit the scope of the invention.

Examples 1-5 and Comparative Examples 1-5 describe the preparation of foams with and without a saccharide and a blowing agent that comprises water. Examples 6-15 describe the preparation of foams prepared from a polyol, a saccharide, a blowing agent that comprises water, and an isocyanate.

Examples 16-17 describe the preparation of foams on a commercial laminator prepared from a polyol, a saccharide, a blowing agent that comprises water, and an isocyanate.

One preferred process for forming a foam as in Examples 16 and 17 can be illustrated with reference to the apparatus shown in FIG. 1. The apparatus includes tanks A, B, C, and D for containing the foamable ingredients and additives such as surfactant, dye, blowing agent, etc. The tanks are charged with the foam-forming mixture in whatever manner is convenient and preferred for the given mixture. For instance, in the production of an isocyanurate foam, the foam-forming mixture can be divided into three liquid components, with polyisocyanate mixture in tank A; the polyol, surfactant, and blowing agent (water) in tank B; in tank C an optional second blowing agent, typically known as an “augmenting” or “trimming” blowing agent; and the catalytic agent in tank D. The tanks are individually connected to outlet lines 1, 2, 3, and 4, respectively. The temperatures of the ingredients in each tank are controlled to ensure satisfactory processing. The lines 1, 2, 3, and 4 form the inlet to metering pumps E, F, G, and H. The apparatus is also provided with a storage tank (not shown) for an optional frothing agent. The storage tank discharges frothing agent into conduit 5 which opens at “T”-intersection line 5 into line 1. A check valve 6 and ball valve 7 in conduit 5 ensure no backup of material toward the frothing agent storage tank. The frothing agent instead can be introduced in the same way into line 2 or both lines 3 and 4. The pumps E, F and G discharge respectively through lines 8, 9, and 10. Blowing agent from tank C is statically mixed in static mixer I with the B-side composition from tank B. Lines 8 and 11 are connected to the extruder J. Optionally, extruder J can be fed metered solids through a metered weigh feeder K. Line 12 and line 13, the D-side pump discharge, are respectively connected to the mixing head L by flexible lines. The apparatus is also provided with a roll M of lower facing material, and a roll M′ of upper facing material. Where only a lower facing material is used, the upper facing material can be replaced with a web coated with a release agent. The apparatus is also provided with metering rolls N and N′, and an oven O provided with vents 15 and 16 for introducing and circulating hot air. The apparatus also includes pull rolls P and P′, each of which preferably has a flexible outer sheath, and cutting means Q for cutting off side excess material and R for severing the faced foam plastic produced into finite lengths, thereby producing discrete panels.

As an example of the operation, tank A is charged with the organic polyisocyanate, tank B is charged with the polyol, blowing agent (water), and surfactant, tank C is charged with alternative or trimming blowing agent, and tank D is charged with catalyst. The speeds of the pumps E, F, G, and H are adjusted to give the desired ratios of the ingredients contained in the tanks A, B, C and D whereupon these ingredients pass respectively into lines 1, 2, 3, and 4. When a froth-foaming process is conducted, the frothing agent is injected into line 1 upstream of metering pump E. The tank B and tank C ingredients pass through lines 9 and 10 and are mixed. Line 8 and line 9 are fed to the extruder exiting via line 12, whereupon line 12 is mixed with the catalyst from line 13 in the mixing head L and deposited therefrom. By virtue of rotation of the pull rolls N and N′, the lower facing material is pulled from the roll M, whereas the upper facing material is pulled from the roll M′. The facing material passes over idler rollers and is directed to the nip between the rotating metering rolls N and N′. The mixing head L sprays the foam in a circular pattern on the lower facing. In this manner, an even amount of material can be maintained upstream of the nip between the metering rolls N & N′. The composite structure at this point comprising lower and upper facing material M and M′ having there between a foamable mixture 14 now passes into the oven O and on along the generally horizontally extending conveyor. While in the oven O, the core expands under the influence of heat added by the hot air from vents 15 and 16 and due to the heat generated in the exothermic reaction between the polyol and isocyanate in the presence of the catalyst. The temperature within the oven is controlled by varying the temperature of the hot air from vents 15 and 16 in order to ensure that the temperature within the oven O is maintained within the desired limits of 100° F. to 300° F. (38° C. to 149° C.), preferably 175° F. to 250° F. (79° C. to 121° C.). The foam, under the influence of the heat added to the oven, cures to form faced foam plastic 17. The product 17 then leaves the oven O, passes between the pull rolls P and P′, and is cut by side edge and length cutting means Q and R into finite lengths, thereby forming discrete panels 18 of the product.

Numerous modifications to the above-described apparatus will be apparent to those skilled in the art. For example, the tanks A, B and C can be provided with refrigeration means in order to maintain the reactants at subambient temperatures. In one modification, the frothing agent is not delivered into lines 1 or 2, but is admixed with the foam-forming ingredient(s) in tanks A and/or B. Such an approach is especially advantageous for handling large amounts of highly volatile frothing agents, which can, for example, be apportioned in tanks A and B which are specially adapted (e.g., pressurized) to hold the frothing agent-containing formulations.

Another variation, not shown, is the addition of a reinforcing web that can be fed into the apparatus. Fiberglass fibers constitute a preferred web material characterized as a thin mat of long, generally straight glass fibers. By generally following the method of foam reinforcement described in Example 1 of U.S. Pat. No. 4,028,158 and utilizing a foam-forming mixture having the consistency of the liquid foamable mixture of this example, the glass mat becomes distributed within the foam core. By virtue of rotation of the pull rolls, reinforcing mat is pulled from its roll, through the nip of the metering rolls and downstream to form an expanded reinforcement material in the resulting structural laminate.

In a simplified variation, the metering of the foamable mixture can be accomplished without the need for metering rolls N and N′ by evenly applying the foamable mixture to the lower facer M and slightly restraining the rising foam so that so that a foam product of consistent density is achieved.

Any facing sheet that can be employed to produce building panels can be employed in the present invention. Examples of suitable facing sheets include, among others, those of kraft paper, aluminum, asphalt impregnated felts, and glass fiber mats, as well as combinations of two or more of the above.

The foams can also be used, with or without one or more facers, for pipe insulation, pour-in-place applications, bunstock, spray foam, and the like.

The foams can be used variety of applications. In the building and construction industry, it can be used as a component of laminated insulation panels for commercial built-up roofing applications; laminated insulation panels for siding applications; fabricated (cut from bunstock) insulation panels and configurations for roofing, piping, and various other insulation applications; in spray foam applications for roofs, tanks, pipes, refrigerators and walls; and as a component of simulated wood products for interior decor and furniture. In the refrigeration industry, the foam can be used in pour-in-place commercial refrigerator insulation. It can also be used in discontinuous panel lamination for freezer and warehouse insulation. For use in providing insulation, a rigid polyurethane foam prepared according to the methods disclosed herein can be applied, for example, onto a supporting substrate. Suitable substrates include structural elements such as, for example, ducts for heat and/or ventilation, walls, modular walls. In some embodiments, a sandwich structure can be formed, including two or more supporting substrates between which a rigid foam is interposed. Supporting substrates can be made, for example, of metal, concrete, brick, wood, plasterboard and the like. In other embodiments, a single supporting substrate can be used, upon which the foam elements are applied by spray application prior to completion of reaction between the elements to form the foam. For example, a delivery device containing the reaction mixture can be used to apply the foam ingredients at a desired location. Such application is suitable for, for example, pour-in-place formation of insulation during assembly of goods such as refrigerators. Further examples of uses and methods of application of foams prepared according to the processes disclosed herein can be found in U.S. patent application US2001/0014387 A1, the disclosures of which are hereby incorporated herein by reference in their entirety.

In examples 1-5, the % volumetric shrinkage was measured to determine the relative degree of crosslinking. The % volumetric shrinkage was defined as the volume percentage of a 2100 ml plastic cup vacated in 5-7 days by shrinkage of the foam cut flush to the cup lip on foaming. The resulting void in the plastic cup was filled with water while holding the foam firmly in the cup. The foam was removed and the volumetric void was determined by weighing the water remaining in the cup.

The following parameters are used to define the foaming profile:

Foaming Mix Time—the time, measured in seconds, that the foam components were actually being mixed by a mechanical agitator.

Foaming Cream Time—the time interval, measured in seconds, from the start of mixing of the ingredients to the visible start of the foaming reaction. The reaction began when the mixture turned a creamy color or when the foam just began to rise.

Foaming Gel Time—the time, measured in seconds, from the beginning of mixing of the polyol and isocyanate components, to reach the degree of polymerization wherein a fiber or string of polymer could be drawn from the reacting mass of the polymer.

Foaming Tack-Free Time—the time interval, measured in seconds, between the start of mixing the ingredients and the time when the surface of the foam did not feel tacky to the hand or did not adhere to a wooden tongue depressor.

Foaming Rise Time—the time interval between the start of mixing of the ingredients and the time when the foam stopped rising in an open container.

The “metal esterification catalyst content” reported for Polyols 1-4 included the residue metal esterification catalyst and glycolates, carboxylates, and other coordination compounds of the metal.

### Comparative Examples 1-5 (CE1-CE5) and Examples 1-5 (EX1-5)

The following examples show foams prepared with and without added saccharide, using a blowing agent comprising water

Rigid polyurethane foams were prepared using a one-shot technique. Specifically, all of the ingredients except the isocyanate were mixed together and then the isocyanate was added. The final mixture was then stirred using a 2200 rpm stirrer outfitted with a 3″ Conn blade for the indicated time and then poured into a 2100 ml plastic cup. The nominal density of the foams prior to shrinkage was between 1.7 and 1.9 pounds per cubic foot. The formulations employed and the results obtained are set forth below in Table 1. The polyol used in CE1-5 and EX1-5 was the commercial aromatic polyester polyol Stepanol® 3152 (The Stepan Company, Northfield, Ill.) which has a hydroxyl number of 322 mg/KOH/g, an acid number of 2.4 mg/KOH/g, an average functionality of 2, and an average molecular weight of 350. Examples 1-5 and Comparative Examples 1-5 illustrate the relative crosslinking in the presence of the water and saccharide components in three different blowing systems—water, HCFC-141b, and a 50/50 iso/cyclo pentane hydrocarbon mix.

TABLE 1

| | CE1 | CE2 | EX1 | EX2 | CE3 | EX3 | CE4 | EX4 | CE5 | EX5 |
|---|---|---|---|---|---|---|---|---|---|---|
| Polyol: Stepanol ® 3152 (wt %) | 42.78 | 38.72 | 35.06 | 35.52 | 39.72 | 36.78 | 41.03 | 38.70 | 41.24 | 29.55 |
| Saccharide: Flour dry basis⁽¹⁾ (wt %) | | | 3.62 | 3.65 | | | | | | |
| Saccharide: Cornstarch dry basis⁽²⁾ | | | | | | 3.93 | | 4.14 | | 3.79 |
| (wt %) | | | | | | | | | | |
| HCFC-141b blowing agent (wt %) | 16.25 | 8.81 | 8.41 | 8.48 | 8.54 | 11.77 | 11.49 | | | |
| Hydrocarbon blowing agent⁽³⁾ (wt %) | | | | | | | | 7.16 | 6.19 | |
| Water blowing agent (wt %) | | 0.92 | 0.87 | 0.84 | 0.85 | 0.49 | 0.49 | 0.51 | 0.78 | 2.01 |
| Triethylamine catalyst (wt %) | 0.17 | 0.15 | 0.14 | 0.14 | 0.14 | 0.15 | 0.16 | 0.15 | 0.16 | 0.15 |
| 33LV⁽⁴⁾ (wt %) | 0.56 | 0.50 | 0.46 | 0.46 | 0.46 | 0.48 | 0.49 | 0.50 | 0.54 | 0.44 |
| DC-193⁽⁵⁾ (wt %) | 1.28 | 1.16 | 1.05 | 1.06 | 1.07 | 1.10 | 1.23 | 1.16 | 1.24 | 1.06 |
| TCPP⁽⁶⁾ (wt %) | 4.28 | 3.87 | 3.50 | 3.53 | 3.77 | 3.68 | 4.10 | 3.87 | 4.12 | 3.58 |
| “B side” total | 65.32 | 54.14 | 53.11 | 53.48 | 54.56 | 58.37 | 59.0 | 56.2 | 54.27 | 40.58 |
| DOW 580N⁽⁷⁾ (wt %) | 34.58 | 45.86 | 46.89 | | | 41.63 | 41.00 | 43.8 | 45.73 | 59.42 |
| MondurMR⁽⁸⁾ (wt %) | | | | 46.52 | 45.44 | | | | | |
| Wt % (dry) saccharide to mixture | 0 | 0 | 3.62 | 3.65 | 0 | 3.93 | 0 | 4.14 | 0 | 3.79 |
| NCO Index | 1.05 | 1.05 | 1.05 | 1.05 | 1.05 | 1.05 | 1.05 | 1.05 | 1.05 | 1.05 |
| Foaming Mix Time (sec.) | 15 | 15 | 15 | 15 | 14 | 15 | 15 | 15 | 15 | 14 |
| Foaming Cream Time (sec.) | 24 | 30 | 18 | 20 | 20 | 22 | 22 | 28 | 18 | 14 |
| Foaming Gel Time (sec.) | 52 | 48 | 42 | 46 | 56 | 43 | 38 | 65 | 56 | 40 |
| Foaming Rise Time (sec.) | 112 | 75 | 65 | 83 | 118 | 85 | 65 | 99 | 91 | 54 |
| Foaming Tack-Free Time (sec.) | 76 | 61 | 53 | 58 | 75 | 56 | 58 | 95 | 71 | 54 |
| Vol. % shrinkage (aged 5-7 days) | 80.6 | 4.5 | 9.2 | 9.0 | 14 | 15.4 | 29.6 | 3.0 | 8.4 | 5.2 |
| Foam Remarks | (a), (b) | (b) | (b) | (b) | (b) | (b) | (b) | (b) | (b) | (b) |

⁽¹⁾Gold Medal General Purpose Flour or Bay State Milling Flour (14% wt water)
⁽²⁾Argo Cornstarch (11% wt water)
⁽³⁾50/50 wt % iso/cyclo pentane blend
⁽⁴⁾Air Products Dabco 33LV Urethane Catalyst (Air Products and Chemicals, Inc., Allentown, Pennsylvania)
⁽⁵⁾Air Products DC-193 silicone surfactant (Air Products and Chemicals, Inc., Allentown, Pennsylvania)
⁽⁶⁾Tris(2-chloropropyl) Phosphate, Antiblaze ® 80, (Rhodia Inc. Cranbury, New Jersey)
⁽⁷⁾Dow Polymeric MDI 580N (The Dow Chemical Co., Midland, Michigan) (having an average functionality of 3.0)
⁽⁸⁾Mondur MR (Bayer Corporation, Pittsburgh, Pennsylvania) (having an average functionality of 2.7)
Foam Remarks:
(a) Control, totally collapsed within 24 hours
(b) Original appearance was of a fine closed cell foam

The foam made in Comparative Example 1, which was made using no water or saccharide, exhibited total collapse. In comparison with CE 1, CE 2 exhibits improvement when water is used.

Comparison of CE3 with Example 2 shows that without the use of a saccharide, foam shrinkage is significantly increased by 50% with the use of a lower-functionality isocyanate; i.e., 50% more shrinkage was observed with the use of Mondur MR in the absence of a saccharide. However, with the use of a saccharide, no difference was observed in shrinkage between the foam made with a higher functionality isocyanate and the foam made with a lower functionality isocyanate.

Comparison of Example 3 with Comparative Example 4 illustrates that without the use of a saccharide, the shrinkage of the foam in Comparative Example 4 was 100% greater than that of the foam in Example 3, which was made with a saccharide.

Comparison of Example 4 with Comparative Example 4 illustrates the significant reduction in shrinkage when a hydrocarbon/water blowing agent was used rather than a HCFC blowing agent. Comparison of Example 4 with Comparative Example 5 illustrates that increasing the amount of water in a water/hydrocarbon blowing agent system by 50 percent, in the absence of a saccharide, does not reduce shrinkage. Example 4 also illustrates that the presence of a hydrocarbon reduces shrinkage.

Comparison of Example 4 and Example 5 illustrates that the presence of a hydrocarbon reduces shrinkage; Example 4 shows the least shrinkage.

### Examples 6-15

The following examples show foams prepared using a water blowing agent, and water with a hydrocarbon co-blowing agent.

In EX6-EX15, four polyols (Polyols 14) were used to prepare the foams.

Polyol 1 was prepared as follows. To a 2 liter reactor equipped with an agitator, 5 stage glass perforated trayed column, condenser, thermocouple, and vacuum system, was added 409 grams of diethylene glycol, 1238 grams of ethylene glycol recovery bottoms having a saponification number of 387 mg KOH/g, a hydroxyl number of 528 mg KOH/g, an acid number of 1.49 mg KOH/g, and 22% free glycol content, 167 grams of a 70% solution of sorbitol, 128 grams of triethanolamine column bottoms, and 1.54 grams of Tyzor PC-42 (a titanate catalyst sold by E. I. du Pont de Nemours and Company, Wilmington, Del.). The resulting reaction mixture was heated over approximately 1.5 hours to 235° C. and held at that temperature for approximately 7 hours. Distillation of water from the sorbitol solution began at about 150° C. A vacuum of 450 mm Hg absolute was pulled for approximately 1 hour. 549 grams of distillate was removed, resulting in Polyol 1 which had the following properties:

Average functionality: 2.7

Hydroxyl number: 313.7 mg/KOH/g

Average molecular weight: 365

Acid number: 1.28 mg/KOH/g

Viscosity: 15,343 cSt at 25° C.

Metal esterification catalyst content: about 570 ppm antimony measured as an oxide, about 125 ppm manganese measured as an oxide, and about 60 ppm titanate measured as an oxide.

Polyol 2 was prepared as follows. To a 2 liter reactor equipped with an agitator, 5 stage glass perforated trayed column, condenser, thermocouple, and vacuum system, was added 851 grams of diethylene glycol, 770 grams of crude terephthalic acid, 326 grams of a 70% solution of sorbitol, 1.65 grams of Tyzor PC42, and 1.31 grams of antimony oxide. The resulting reaction mixture was then heated over approximately 1.5 hours to 230° C. and held at that temperature for approximately 4.5 hours, at which time the mixture cleared. The temperature was then decreased to 220° C. while pulling a vacuum slowly to approximately 155 mmHg. 311 grams of distillate was removed over approximately 5 hours, resulting in Polyol 2 which had the following properties:

Average functionality: 2.7

Hydroxyl number: 338 mg/KOH/g

Average molecular weight: 365

Acid number: 1.75 mg/KOH/g

Viscosity: 20,637 cSt at 25° C.

Metal esterification catalyst content: about 1000 ppm antimony measured as an oxide and about 60 ppm titanate measured as an oxide

Polyol 3 was prepared as follows. To a 2 liter reactor equipped with an agitator, 5 stage glass perforated trayed column, condenser, thermocouple, and vacuum system, was added 721 grams of diethylene glycol, 1105 grams of low molecular weight (about 8,000-10,000 MW) polyethylene terephthalate (having an inherent viscosity of 0.25 dl/g, 275 ppm antimony; 2.0% w/w isophthalic acid; 20 ppm phosphorous; 1.7% w/w diethylene glycol; 5 ppm organic toner), 273 grams of a 70% aqueous solution of sorbitol, and 1.8 grams of Tyzor® PC-42. Next, the reaction mixture was heated over approximately 1.5 hours to 225° C. and held at that temperature for approximately 9 hours. Vacuum was then pulled to approximately 440 mmHg with the reaction continuing for approximately another hour. 316 grams of distillate was removed during both steps resulting in Polyol 3 which had the following properties:

Average functionality: 2.7

Hydroxyl number: 401.2 mg/KOH/g

Average molecular weight: 365

Acid number: 1.26 mg/KOH/g

Viscosity: 18,606 cSt at 25° C.

Metal esterification catalyst content: about 350 ppm antimony measured as an oxide and about 60 ppm titanate measured as an oxide.

Polyol 4 was prepared as follows. To a 2 liter reactor equipped with an agitator, 5 stage glass perforated trayed column, condenser, thermocouple, and vacuum system, was added 795 grams of diethylene glycol, 701 grams of crude terephthalic acid, 232 grams of a 70% solution of sorbitol, 110 grams of triethanolamine column bottoms, 1.45 grams of Tyzor PC-42, and 1.38 grams of antimony oxide. Next, the reaction mixture was heated over approximately 1.5 hours to 210° C. and held that temperature for approximately 2.75 hours when mixture cleared. The temperature was then increased to 225° C. while pulling a vacuum slowly to approximately 260 mmHg. 68 grams of excess diethylene glycol was added to facilitate water removal. 263 grams of total distillate was removed over approximately 10 hours resulting in Polyol 4 which had the following properties:

Average functionality: 2.7

Hydroxyl number: 299.5 mg/KOH/g

Average molecular weight: 365

Acid number: 2.31 mg/KOH/g

Viscosity: 15,562 cSt at 25° C.

Metal esterification catalyst content: about 1000 ppm antimony measured as an oxide and about 60 ppm titanate measured as an oxide

Rigid foams were prepared from Polyols 1-4 using the one-shot technique. Specifically, all of the ingredients except the isocyanate were mixed together and then the isocyanate was added. The final mixture was then stirred using a 2200 rpm stirrer outfitted with a 3″ Conn blade for the indicated time and then poured into a 8×8×8 inch box. The formulations employed and the results are set forth below in Table 2.

TABLE 2
Properties of Foams Blown in Water/HC Co-Blow Systems

| | EX6 | EX7 | EX8 | EX9 | EX10 | EX11 | EX12 | EX13 | EX14 | EX15 |
|---|---|---|---|---|---|---|---|---|---|---|
| Polyol 1 (w %) | | | 33.55 | | | | | | | |
| Polyol 2 (t %) | | | | | | | | | | 27.36 |
| Polyol 3 (w %) | | | | | 33.00 | | | | 25.00 | |
| Polyol 4 (wt %) | 31.14 | 30.74 | | 36.57 | | 34.74 | 36.23 | 28.74 | | |
| Flour dry basis⁽¹⁾ | 3.21 | 3.17 | | | 3.41 | 3.59 | 3.40 | 2.97 | | |
| (wt %) | | | | | | | | | | |
| Cornstarch dry | | | | | | | | | | 2.92 |
| basis⁽²⁾ (wt %) | | | | | | | | | | |
| Cornsyrup dry | | | 2.42 | 3.53 | | | | | 3.03 | |
| basis⁽³⁾ (wt %) | | | | | | | | | | |
| Hydrocarbon | | | 4.36 | 4.39 | 5.61 | 4.17 | 4.35 | 3.88 | 4.25 | 4.79 |
| blowing agent⁽⁴⁾ | | | | | | | | | | |
| (wt %) | | | | | | | | | | |
| Water blowing | 2.08 | 2.11 | 1.61 | 1.17 | 0.96 | 1.17 | 1.19 | 1.11 | 0.86 | 0.77 |
| agent (wt %) | | | | | | | | | | |
| 33LV⁽⁵⁾ (wt %) | 0.06 | 0.06 | 0.17 | | 0.40 | 0.07 | 0.07 | 0.06 | 0.30 | 0.16 |
| 15% K octoate⁽⁶⁾ | | | | | | | | 0.29 | 0.25 | |
| (wt %) | | | | | | | | | | |
| K215⁽⁷⁾ (wt %) | | | | | | | | | | 0.19 |
| TMR-2⁽⁸⁾ (wt %) | | | | | | | | | | 0.60 |
| DC-193⁽⁹⁾ (wt %) | 0.93 | 0.42 | 1.01 | 1.10 | 0.99 | 1.04 | 0.49 | 0.86 | 0.93 | 0.82 |
| TCPP⁽¹⁰⁾ (wt %) | 3.11 | 2.79 | 3.35 | 3.66 | 3.30 | 3.47 | 3.29 | 2.87 | 3.10 | 2.74 |
| Rhodia ESC-70⁽¹¹⁾ | | 0.95 | | | | | 1.12 | | | |
| (wt %) | | | | | | | | | | |
| “B side” Total | 40.54 | 40.25 | 46.48 | 50.41 | 47.65 | 48.26 | 50.15 | 40.78 | 37.72 | 40.35 |
| Dow 580N⁽¹²⁾ (wt %) | | | 53.32 | | | | | | | 59.65 |
| Mondur 489⁽¹³⁾ | 59.46 | 59.75 | | 49.59 | 52.35 | 51.74 | 49.85 | 59.22 | 62.28 | |
| (wt %) | | | | | | | | | | |
| Ingredient total | 100 | 100 | 100 | 100 | 100 | 100 | 100 | 100 | 100 | 100 |
| Wt % (dry) | 3.21 | 3.17 | 2.42 | 3.53 | 3.41 | 3.59 | 3.40 | 2.97 | 3.03 | 2.92 |
| saccharide to | | | | | | | | | | |
| mixture | | | | | | | | | | |
| NCO Index | 1.05 | 1.05 | 1.04 | 1.05 | 1.05 | 1.12 | 1.05 | 1.45 | 1.40 | 1.64 |
| Foaming Mix Time | 13 | 13 | 12 | 13 | 17 | 10 | 12 | 14 | 20 | 15 |
| (sec.) | | | | | | | | | | |
| Foaming Cream | 17 | 23 | 13 | 17 | 20 | 15 | 13 | 17 | 39 | 23 |
| Time (sec.) | | | | | | | | | | |
| Foaming Gel Time | 62 | 67 | 47 | 88 | 55 | 59 | 65 | 60 | 70 | 58 |
| (sec.) | | | | | | | | | | |
| Foaming Rise Time | 95 | 110 | 80 | 180 | 93 | 100 | 110 | 120 | 140 | 65 |
| (sec.) | | | | | | | | | | |
| Foaming Tack-Free | 89 | 98 | 65 | 140 | 83 | 88 | 97 | 86 | 125 | 93 |
| Time (sec.) | | | | | | | | | | |
| Foam Density | 1.72 | 1.76 | 1.68 | 1.33 | 1.68 | 1.62 | 1.79 | 1.8 | 1.79 | 1.70 |
| (PCF) | | | | | | | | | | |
| Vol. % shrinkage (aged | 0 | 0 | 0 | 0 | 0 | 0 | 0 | 0 | 0 | 0 |
| 5-7 days) | | | | | | | | | | |
| Free Rise | 18.3 | 22.6 | 20.2 | 17.3 | 25.8 | 22.6 | 30.1 | 28.3 | 30.1 | 27.5 |
| Compressive | | | | | | | | | | |
| Strength (PSI) | | | | | | | | | | |
| Thermal | (14) | 5.263 | 5.910 | 4.533 | 5.277 | 5.656 | 5.061 | 5.855 | 5.767 | 6.124 |
| Conductivity (R/in) | | | | | | | | | | |
| Closed Cell | 98.2 | 98.2 | 100 | 94.02 | 94.4 | 98.1 | 91.9 | 97.5 | 100 | 96.9 |
| Content % | | | | | | | | | | |

⁽¹⁾Gold Medal General Purpose Flour or Bay State Milling Flour (14% wt water)
⁽²⁾Argo Cornstarch (11% wt water)
⁽³⁾Karo brand light corn syrup
⁽⁴⁾50/50 wt % iso/cyclo pentane blend
⁽⁵⁾Air Products Dabco 33LV Urethane Catalyst (Air Products and Chemicals, Inc., Allentown, Pennsylvania)
⁽⁵⁾Air Products Dabco 33LV Urethane Catalyst (Air Products and Chemicals, Inc., Allentown, Pennsylvania)
⁽⁶⁾15% Potassium Octoate (Shepard Chemical)
⁽⁷⁾Air Products K215 Catalyst (Air Products and Chemicals, Inc., Allentown, Pennsylvania)
⁽⁸⁾Air Products TMR-2 Catalyst (Air Products and Chemicals, Inc., Allentown, Pennsylvania)
⁽⁹⁾Air Products DC-193 silicone surfactant (Air Products and Chemicals, Inc., Allentown, Pennsylvania)
⁽¹⁰⁾Tris(2-chloropropyl) Phosphate, Antiblaze ® 80, (Rhodia Inc., Cranbury, New Jersey)
⁽¹¹⁾ESC-70 A/B (32% water) (Rhodia Inc., Cranbury, New Jersey)
⁽¹²⁾Dow Polymeric MDI 580N (The Dow Chemical Co., Midland, Michigan)
⁽¹³⁾Mondur 489 (Bayer Corporation, Pittsburgh, Pennsylvania)
⁽¹⁴⁾Sampled curled on cutting

All the foams of Table 2 had closed cell content greater than 90% whether a 100% water blowing agent or a water/hydrocarbon blowing system was used. The foams also exhibited unexpected thermal resistance and free rise compressive strength for their densities. No apparent difference was observed between the use of a solid saccharide and the use of a liquid saccharide. Also, the use of ionic and nonionic surfactants in addition to minor amounts of silicone surfactant made no detectable difference.

The foams disclosed in Examples 6 and 7 were made using 100% water as blowing agent. The foam was formed on a cardboard box support, and it was observed that, upon cutting away the foam in Example 6 from the support, the foam cells at the cut surface ruptured and/or released the entrapped carbon dioxide, causing the foam to shrink and warp.

Example 8 illustrates the properties of a low-index polyurethane foam made using a liquid saccharide (corn syrup). The foam exhibited 100% closed cells and unexpected thermal resistance for its density.

Example 9 illustrates a low index foam having high closed cell content, a relatively low density, excellent compressive strength, and good thermal resistance for its very low density.

Example 10 and 11 illustrates the use of flour as a saccharide source.

Examples 7 and 12 illustrate the use of alternative surfactants such as Rhodia ESC-70 A/B, a blend of proprietary Rhodia nonionic and anionic surfactants.

The foams had excellent closed cell content, free rise compressive strength and slightly lower thermal resistance for their density.

Examples 13-15 illustrate the formation of polyisocyanurate (PIUR) foams, using flour, cornstarch, and corn syrup as saccharide sources. As the term is used herein, PIUR foams are foams having an isocyanate index of about 3.0 or less. The foams have compressive strengths greater than 27.5 psi, and greater than 96% closed cell content.

### Examples 16 and 17

### Laminate Preparation

Structural laminates were prepared from the ingredients and quantities thereof shown in the Table 1. A free rise process was employed. For each structural laminate, the B-side (polyol) component was charged to tank B, the D-side (catalyst) component was charged to tank D, the C-side (blowing agent) component was charged to tank A, and the A-side (polymeric MDI) component was charged to tank A. Laminate examples 1 through 9 utilized fibrous glass mat facings.

In each case, the C-side component was statically mixed with the B-side component prior to mixing with the A-side component. The A-side component was fed to an extruder (J) turning at approximately 650 RPM at one end and mixed for approximately 5 to 10 seconds with the B-side component in the extruder. In Examples 3 and 5, a solid saccharide (flour) was also fed into the extruder and mixed with the A-side component prior to mixing with the B-side & D-side components. In the mixing head, the D-side component was mixed with the other foam components exiting the extruder. The mix head was a spiral grooved mix head assembly spinning between approximately 5000 to 6000 RPM. Top and bottom fibrous glass mat facings were fed together toward the nip of metering rolls M and M′. The foam forming mixture was metered and deposited onto the lower facing. The laminates proceeded through the laminator oven (0) where the oven's conveyor slats rose and fell to establish the final product thickness. The laminate boards were cut to yield the foam board Examples 16 and 17. Properties of the foam boards are given in Table 3. Standard test methods therein identified were used except in the case of cell size. Cell sizes were determined using Image Analysis of scanning electron microscope (SEM) images, as described hereinabove. As an illustration of the variability of cell size measurements with measurement technique, optical measurement by confocal analysis was used to measure cell sizes in the foams prepared in examples 3, 6a, and 10. The measurements obtained were: 122 microns by SEM and 45 microns by confocal analysis; 107 microns by SEM and 43 microns by confocal analysis; and 151 microns by SEM and 49 microns by confocal analysis, respectively.

TABLE 3
Production of Structural Laminates

| INGREDIENTS (wt % | | |
|---|---|---|
| total polymer) | EX16 | EX17 |
| “A” Component | | |
| Polymeric | 48.50 | 58.34 |
| Isocyanate⁽¹⁾ | | |
| “B” Component | | |
| Polyol A⁽²⁾ | 38.42 | |
| Polyol B⁽³⁾ | | 28.22 |
| Water | 1.03 | 1.45 |
| TCPP⁽⁴⁾ | 3.65 | 3.53 |
| DC-193⁽⁵⁾ | 0.85 | 0.85 |
| Organic Filler⁽⁶⁾ | 3.21 | 3.53 |
| dry wt. | | |
| “C” Component | | |
| iso/cyclo pentane⁽⁷⁾ | 4.42 | 2.82 |
| “D” Component | | |
| Dabco 33LV⁽⁸⁾ | 0.39 | |
| Polycat P-18⁽⁹⁾ | | 0.62 |
| Potassium octoate⁽¹⁰⁾ | | 0.93 |
| Potasium acetate⁽¹¹⁾ | | 0.21 |
| Total | 100 | 100 |
| Index | 1.05 | 1.36 |
| FOAM PROPERTIES | | |
| Board Thickness | 1.5 | 1.5 |
| (in.) | | |
| Core Density⁽¹²⁾ | 2.06 | 1.71 |
| Closed cell % | 89.2 | 49.2 |
| (ASTM D2856) | | |
| Compressive | 17.1 | 14.2 |
| Strength (psi) | | |
| (ASTM D1621) | | |
| Cell Size | 122 | 133 |
| (microns) by | | |
| SEM | | |
| Cell Size | 45 | NT |
| (microns) by | | |
| Optical (confocal) | | |
| analysis | | |
| k-factors (ASTM C518) | | |
| (BTU. ln/ft²-hr-F°) | | |
| 1 week | 0.146 | 0.169 |
| 180 days⁽¹³⁾ | 0.158 | 0.1899 |
| Calorimeter | NT | Pass |
| (FM4450) | | |

Note:
NT means not tested
⁽¹⁾Bayer Mondur 489 (Bayer Corporation, Pittsburg, Pennsylvania)
⁽²⁾Aromatic Polyester Polyol characterized by functionality of 2.7-3.0, OHN 347, AN 2.06, visc ˜8 M cPs @25 C
⁽³⁾Aromatic Polyester Polyol characterized by functionality 2.7-3.0, OHN 343, AN 2.3, visc. ˜16 M cPs @ 25 C
⁽⁴⁾Tris (2-chloropropyl) phosphate; Rhodia Antiblaze 80 (Rhodia, Inc., Cranbury, New Jersey)
⁽⁵⁾Silicone surfactant by Air Products (Air Products and Chemicals, Inc., Allentown, Pennsylvania)
⁽⁶⁾Bay State Milling Flour (14% wet) (Bay State Milling Company, Quincy, Massachusetts)
⁽⁷⁾50/50 wt % isopentane/cyclopentane blend
⁽⁸⁾Urethane catalysis by Air Products (Air Products and Chemicals, Inc., Allentown, Pennsylvania)
⁽⁹⁾Urethane catalysis by Air Products (Air Products and Chemicals, Inc., Allentown, Pennsylvania)
⁽¹⁰⁾15% Potassium Octoate (K-15) (The Shepperds Chemical Company, Norwood, Ohio)
⁽¹¹⁾48% Potassium Acetate (Pelron 9648) (The Ele' Corporation, Lyons, Illinois)
⁽¹²⁾Core density is defined as 60% of the center mass of foam with the facing cut off.
⁽¹³⁾Aged 180 to 190 days at ambient lab temperature and humidity conditions

Samples were sliced to prepare a surface for SEM imaging. Images are collected using a JEOL840 SEM. The images are of only the top surface of the cut slice, and provide an indication of where each cell's boundary starts. The long axes of the cells are measured using the SEM images collected. Average cell size can then be calculated. Average “equivalent diameter” can also be used to describe the cell size. Ten cells of each sample are randomly taken to estimate the aspect ratio value for the sample.

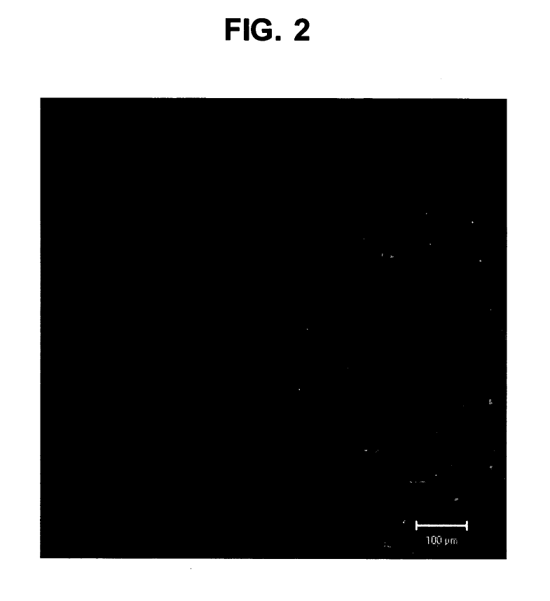

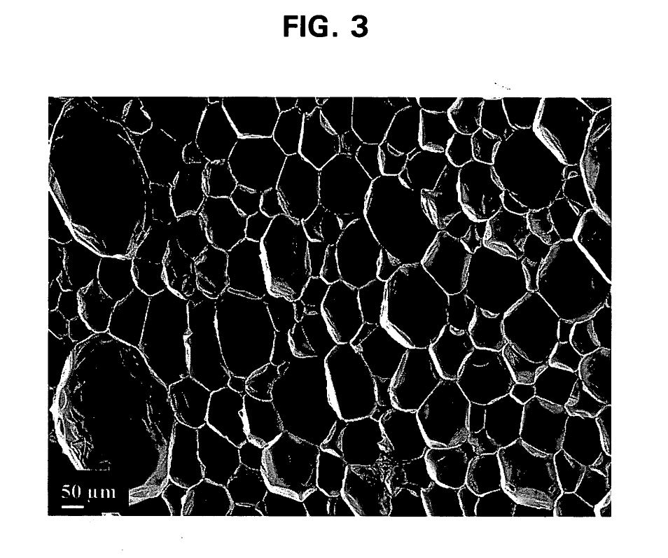

FIG. 2 is an optical confocal micrograph image the foam produced according to Example 3. FIG. 3 is a scanning electron micrograph of the foam produced according to Example 3.

Laminate foams prepared according to the present invention using in the reaction mixture more than 7 to 10 times the typical water content in commercial foams compare favorably with regard to thermal resistance to such commercial foams. The commercial formulation used for reference with regard to water content was the laminate formulation recommended by Kosa in its technical bulletin for Kosa Terate® 3522 aromatic polyester polyol (technical bulletin, page 3).

Examples 16 and 17 illustrate 1.5 inch laminate polyurethane indexed foam utilizing a water/pentane blowing system containing about 7 times and 10 times, respectively, the typical water content of a foaming mix. The laminates made in Examples 16 and 17 have 180-day-aged k-factors of 0.158 and 0.1899 respectively, and R/in. values of 6.33 and 5.26, respectively.

Thus, foams produced according to the processes disclosed herein have thermal properties comparable to those of commercial foams, even though a much higher water content is used in making the present foams than in making known commercial foams. This is surprising because it is generally expected that higher k-factors and lower R values would be obtained with a water content as high as that used in the processes herein.

What is claimed is:

1. A process for forming a rigid, closed cell foam having an isocyanate index from about 0.8 to about 3.0, comprising reacting a mixture that comprises:
(a) an aromatic polyester polyol having an average functionality of about 3.0 or less, a hydroxyl number above 100 mg/KOH/g, and an average molecular weight less than 3000;
(b) from about 1 weight percent to about 30 weight percent of a saccharide, based on the total weight of said mixture;
(c) a blowing agent that comprises water;
(d) an isocyanate.

2. The process of claim 1 wherein the isocyanate index is about 2.7 or less.

3. The process of claim 1 wherein said foam has an insulation R value of at least about 4.5.

4. The process of claim 1 wherein the amount of said saccharide is from about 2 to about 10 weight percent of said mixture.

5. The process of claim 1 wherein the amount of said saccharide is from about 3 to about 5 weight percent of said mixture.

6. The process of claim 1 wherein said saccharide is a polysaccharide.

7. The process of claim 6 wherein said polysaccharide is in a form selected from starches and flour.

8. The process of claim 1 wherein said saccharide is in the form of a syrup.

9. The process of claim 8 wherein said syrup is corn syrup.

10. The process of claim 1 wherein said saccharide is a simple sugar.

11. The process of claim 1 wherein said saccharide is selected from xylose, mannitol, and sorbitol.

12. The process of claim 1 wherein said saccharide comprises sorbitol.

13. The process of claim 1 wherein said foam is a polyurethane foam having an isocyanate index from about 0.8 to about 2.5.

14. The process of claim 1 wherein said foam is a polyisocyanurate foam having an isocyanate index of about 1.0 to about 1.7.

15. The process of claim 1 wherein said isocyanate index is from about 1.0 to about 1.3.

16. The process of claim 1 wherein the average functionality of said polyol is 2.5 or less.

17. The process of claim 1 wherein the average functionality of said polyol is 2.3 or less.

18. The process of claim 1 wherein the average functionality of said isocyante is 2.7 or less.

19. The process of claim 1 wherein said blowing agent further comprises a hydrocarbon.

20. The process of claim 1 wherein said blowing agent consists essentially of water.

21. A rigid, closed cell foam, formed in a process comprising reacting a mixture that comprises:
(a) an aromatic polyester polyol having an average functionality of about 3.0 or less, a hydroxyl number above 100 mg/KOH/g, and an average molecular weight less than 3000;
(b) from about 1 weight percent to about 30 weight percent of a saccharide, based on the total weight of said mixture;
(c) a blowing agent that comprises water; and
(d) an isocyanate;
said foam having an index from about 0.8 to about 3.0.

22. The foam of claim 21 wherein the isocyanate index is about 2.7 or less.

23. The foam of claim 21 wherein said foam has an insulation R value of at least about 4.5.

24. The foam of claim 21 wherein the amount of said saccharide is from about 2 to about 10 weight percent of said mixture.

25. The foam of claim 21 wherein the amount of said saccharide is from about 3 to about 5 weight percent of said mixture.

26. The foam of claim 21 wherein said saccharide is a polysaccharide.

27. The foam of claim 21 wherein said polysaccharide is in a form selected from starches and flour.

28. The foam of claim 21 wherein said saccharide is in the form of a syrup.

29. The foam of claim 21 wherein said syrup is corn syrup.

30. The foam of claim 21 wherein said saccharide is a simple sugar.

31. The foam of claim 21 wherein said saccharide is selected from xylose, mannitol, and sorbitol.

32. The foam of claim 21 wherein said saccharide comprises sorbitol.

33. The foam of claim 21 wherein said foam is a polyurethane foam having an isocyanate index from about 0.8 to about 2.5.

34. The foam of claim 21 wherein said foam is a polyisocyanurate foam having an isocyanate index of about 1.0 to about 1.7.

35. The foam of claim 21 wherein said isocyanate index is from about 1.0 to about 1.3.

36. The foam of claim 21 wherein the average functionality of said polyol is 2.5 or less.

37. The foam of claim 21 wherein the average functionality of said polyol is 2.3 or less.

38. The foam of claim 21 wherein the average functionality of said isocyante is 2.7 or less.

39. The foam of claim 21 wherein said blowing agent further comprises a hydrocarbon.

40. The foam of claim 21 wherein said blowing agent consists essentially of water.
